(19) United States
(12) Patent Application Publication
(10) Pub. No.: US 2007/0104866 A1
(43) Pub. Date: May 10, 2007

(54) Encapsulated emulsions and methods of preparation

(76) Inventors: David Julian McClements, Northampton, MA (US); Eric Andrew Decker, Sunderland, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/528,857

(22) Filed: Sep. 28, 2006

Related U.S. Application Data
(60) Provisional application No. 60/721,287, filed on Sep. 28, 2005.

(51) Int. Cl. B01J 13/02

(52) U.S. Cl. 427/213.3

(57) ABSTRACT

Coated emulsion compositions which can be dried to particulate form, and related methods of use and preparation.

This invention claims priority benefit from application Ser. No. 60/721,287 filed Sep. 28, 2005, the entirety of which is incorporated herein by reference.

The United States government has certain rights to this invention pursuant to Grant No. 2002-35503-12296 from the Department of Agriculture to the University of Massachusetts.

### BACKGROUND OF THE INVENTION

Omega-3 Polyunsaturated fatty acids (PUFAs), especially EPA (eicosapentaenoic acid) and DHA (docosahexaenoic acid), have been shown to be important for maintenance of good health and prevention of a range of human diseases and disorders. For instance, tuna oil contains considerable amounts of omega-3 PUFAs and may be a useful dietary supplement. However, long-chain PUFAs in tuna oils are highly unsaturated and therefore are highly susceptible to oxidation. Lipid oxidation can be reduced by addition of antioxidants to the oil or by microencapsulation of the oil.

Microencapsulation of materials susceptible to oxidation has been shown to significantly retard oxidation. Microencapsulation is a process whereby particles of sensitive or bioactive materials are covered with a thin film of a coating or wall material. The hydrophobic core material is usually homogenized in the presence of an aqueous solution containing an emulsifier (e.g., surfactant, phosopholipid or biopolymer) that forms a protective coating around the oil droplets, and then wall materials are mixed with the resulting emulsion. The emulsion is then dried to remove the water (e.g., by spray or freeze drying), which leads to the formation of oil droplets surrounded by emulsifier molecules that are entrapped within a wall matrix, comprising typically a carbohydrate, protein and/or polar lipid.

A stable emulsion is a prerequisite for successful microencapsulation, and typically involves utilization of a wall material that forms a continuous matrix between the oil droplets in a particle. This wall material is usually composed of relatively low molecular weight carbohydrates, such as corn syrup solids and/or maltodextrin. Corn syrup solids (CCS) can be added to oil-in water emulsions at fairly high concentrations (e.g., ≦25 wt %) without appreciably affecting emulsion stability and rheology.

As the term would imply, spray-drying involves converting a feed material from a fluid state into a powdered state (e.g., amorphous or crystalline solid) by spraying it into a drying medium (usually hot air or an inert gas) to evaporate a carrier liquid such as water surrounding a particulate matter. The feed material is typically pumped through a nozzle that disburses it into small droplets which are then mixed with a hot drying medium. Internal carrier liquid is evaporated from the droplet surfaces, an endothermic process maintaining the droplet material at a relatively low temperature during drying to reduce damage to any thermally-sensitive component. Residence time in the dryer apparatus is also short, thereby minimizing the incidence of thermal damage. The dried material is then separated from the drying medium and removed from the dryer apparatus.

A number of factors can affect the overall quality and commercial viability of a spray-dried powdered product, such factors including but not limited to wall material and total solids content, product solubility and dispersion characteristics, appearance and susceptibility to chemical or oxidative degradation. A schematic representation of encapsulation of oil droplets in spray-dried powdered particles is shown in FIG. 1. An oil in water emulsion with an appropriate amount of a continuous phase material is dried, in the presence of a suitable wall material, to form the corresponding powdered particles.

While widely used in the art, spray-drying is not without certain concerns and limitations. For instance, certain systems require a cost prohibitive amount of wall material for stability. The resulting powder can be vulnerable to degradative action, adversely affecting particulate taste or odor. And, if reconstituted, some powders can aggregate or settle, to the detriment of product appearance.

### BRIEF DESCRIPTION OF THE DRAWINGS

FIGS. 1. A schematic representation showing emulsion preparation of the prior art.

FIGS. 2A-B. Schematic illustrations showing representative (A) single-step and (B) two-step mixing embodiments of this invention.

FIGS. 3A-B. Representative electronic micrographs showing the outer morphology (A) and inner structure (B) of tuna oil-containing capsules. W=wrinkle, P=pore, V=void, R=resin, OD=oil droplet or air cell.

FIG. 4. Mean droplet distribution of original and reconstituted tuna oil emulsion (5 wt % oil, 1 wt % lecithin, 0.2 wt % chitosan and 20 wt % corn syrup solid).

FIG. 5. Influence of stirring time on mean particle diameter and concentration of emulsion after powdered was added to the stirring cell of laser diffraction instrument.

FIG. 6. Influence of medium pH on mean particle diameter of reconstituted emulsion of spray-dried powdered. For each column, means followed by different letters differ significantly (P<0.05) FIG. 7. Influence of medium pH on ζ-potential of reconstituted emulsion of spray-dried powdered

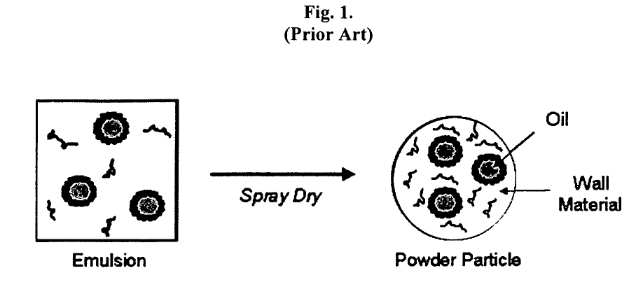

### SUMMARY OF THE INVENTION

In light of the foregoing, the present invention can provide a range of particulate, encapsulated compositions and methods for their assembly and preparation, thereby overcoming various concerns in the art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It is an object of the present invention to provide a hydrophobic oil/fat component designed as described herein to improve the economic, physicochemical, and/or functional properties of a corresponding spray-dried material.

It can also be another object of the present invention to provide such a composition comprising a wall material in a quantity lower than otherwise known in the art for particle stability.

It can be another object of the present invention to provide powdered particle compositions and/or methods for their preparation to impede or prevent destabilization during storage and/or subsequent application.

It can also be another object of the present invention to provide such compositions a structural design to reduce or prevent oil/fat droplet aggregation before, during and/or after encapsulation.

It can also be another object of the present invention to provide such compositions and/or their methods for preparation, thereby improving dispersibility upon reconstitution.

It can be another object of the present invention, alone or in conjunction with one or more of the preceding objectives, to prepare such compositions using food grade materials and currently-available production techniques, modified or adapted as explained in more detail, below, in conjunction with this invention.

Other objects, features, benefits and advantages of the present invention will be apparent from this summary and the following descriptions of certain embodiments, and will be readily apparent to those skilled in art having knowledge of aqueous and powdered emulsions, related food products and associated production techniques. Such objects, features, benefits and advantages will be apparent from the above as taken into conjunction with the accompanying examples, data, figures and all reasonable inferences to be drawn there from, alone or with consideration of the references incorporated herein.

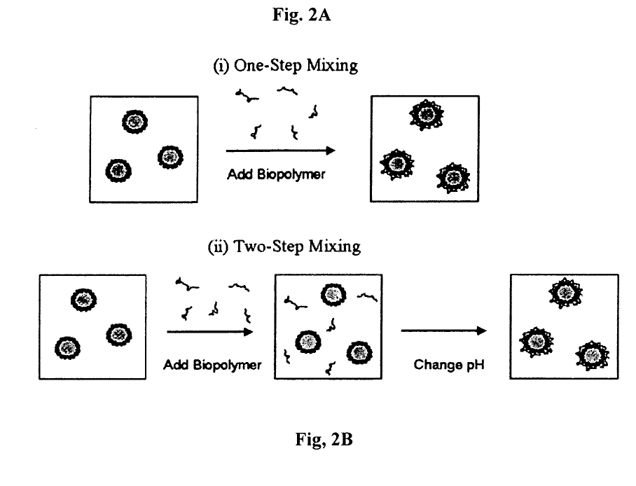

In part, this invention provides a method for preparation of an emulsified substantially hydrophobic oil/fat component. Such a can method comprise: providing an oil/fat component; contacting the oil/fat component with an emulsifier component, at least a portion of which has a net charge; and contacting or incorporating therewith one or more food-grade polymeric components, at least a portion of each comprising a net charge opposite that of the emulsifier component and/or a previously contacted/incorporated food-grade polymeric component. Contact or incorporation of a wall component either before, after or with one of the emulsifier or polymeric components provides a system for powder/particle formation via spray- or freeze-drying. Reference is made to FIG. 2A, a schematic representation for production of oil/fat droplets in powder particles. For instance, an aqueous emulsion of oil droplets surrounded by a multi-layered composition or component membrane can be spray-dried to provide a corresponding particulate material.

Accordingly, in certain embodiments, such a method can comprise alternating contact or incorporation of oppositely charged emulsifier and food-grade polymeric components, each such contact or incorporation comprising electrostatic interaction with a previously contacted or incorporated emulsifier or polymeric component. Such methods can optionally comprise mechanical agitation and/or sonication of the resulting compositions to disrupt any aggregation or flocs formed.

In accordance with the preceding, a hydrophobic component can be at least partially insoluble in an aqueous or another medium and/or is capable of forming emulsions in an aqueous or another medium. In certain embodiments, the hydrophobic component can comprise a fat or an oil component, including but not limited to, any edible food oil known to those skilled in the art (e.g., corn, soybean, canola, rapeseed, olive, peanut, algal, nut and/or vegetable oils, fish oils or a combination thereof). The hydrophobic component can be selected from hydrogenated or partially hydrogenated fats and/or oils, and can include any dairy or animal fat or oil including, for example, dairy fats. In addition, the hydrophobic component may further comprise components such as flavors, preservatives and/or nutritional components, such as fat soluble vitamins, at least partially miscible therewith.

It will be readily apparent that, consistent with the broader aspects of the invention, the hydrophobic component can further include any natural and/or synthetic lipid components including, but not limited to, fatty acids (saturated or unsaturated), glycerols, glycerides and their respective derivatives, phospholipids and their respective derivatives, glycolipids, phytosterol and/or sterol esters (e.g. cholesterol esters, phytosterol esters and derivatives thereof), carotenoids, terpenes, antioxidants, colorants, and/or flavor oils (for example, peppermint, citrus, coconut, or vanilla), as may be required by a given food or beverage end use application. The present invention, therefore, contemplates a wide range of oil/fat and/or lipid components of varying molecular weight and comprising a range of hydrocarbon (aromatic, saturated or unsaturated), alcohol, aldehyde, ketone, acid and/or amine moieties or functional groups.

An emulsifier component can comprise any food-grade surface active ingredient, cationic surfactant, anionic surfactant and/or non-ionic surfactant known to those skilled in the art capable of at least partly emulsifying the hydrophobic component, as can be in an aqueous phase. The emulsifier component can include small-molecule surfactants, phospholipids, proteins and polysaccharides. Such emulsifiers can further include, but are not limited to, lecithin, chitosan, pectin, gums (e.g. locust bean gum, gum arabic, guar gum, etc.), alginic acids, alginates and derivatives thereof, and cellulose and derivatives thereof. Protein emulsifiers can include any one of the dairy proteins, vegetable proteins, meat proteins, fish proteins, plant proteins, egg proteins, ovalbumins, glycoproteins, mucoproteins, phosphoproteins, serum albumins, collagen and combinations thereof. Protein emulsifying components can be selected on the basis of their amino acid residues (e.g., lysine, arginine, asparatic acid, glutamic acid, etc.) to optimize the overall net charge of the interfacial membrane about the hydrophobic component, and therefore the stability of the hydrophobic component within the resultant emulsion system.

Indeed, the emulsifier component can include a broad spectrum of emulsifiers including, for example, acetic acid esters of monogylcerides (ACTEM), lactic acid esters of monogylcerides (LACTEM), citric acid esters of monogylcerides (CITREM), diacetyl acid esters of monogylcerides (DATEM), succinic acid esters of monogylcerides, polyglycerol polyricinoleate, sorbitan esters of fatty acids, propylene glycol esters of fatty acids, sucrose esters of fatty acids, mono and diglycerides, fruit acid esters, stearoyl lactylates, polysorbates, starches, sodium dodecyl sulfate (SDS) and/or combinations thereof.

As discussed above, a polymeric component can comprise any food-grade polymeric material capable of adsorption, interaction and/or linkage to the hydrophobic component and/or an associated emulsifier component. Accordingly, the food-grade polymeric component can be a biopolymer material selected from, but not limited to, proteins, ionic or ionizable polysaccharides such as chitosan and/or chitosan sulfate, cellulose, pectins, alginates, nucleic acids, glycogen, amylose, chitin, polynucleotides, gum arabic, gum acacia, carageenan, xanthan, agar, gellan gum, tragacanth gum, karaya gum, locust bean gum, lignin and/or combinations thereof. The food-grade polymeric component may alternatively be selected from modified polymers such as modified starch, carboxymethyl cellulose, carboxymethyl dextran or lignin sulfonates.

The present invention contemplates any combination of emulsifier and polymeric components leading to the formation of a multi-layered composition comprising an oil/fat and/or lipid component sufficiently stable under environmental or end-use conditions applicable to a particular food product. Accordingly, a hydrophobic component can be encapsulated with and/or immobilized by a wide range of emulsifiers/polymeric components, depending upon the pH, ionic strength, salt concentration, temperature and processing requirements of the emulsion system/food product into which a hydrophobic component is to be incorporated. Such emulsifier/polymeric component combinations are limited only by electrostatically interaction one with another and formation of a corresponding emulsion, in the presence of a suitable wall component, which can be spray- or freeze-dried or otherwise processed to a powdered or particulate material. Such hydrophobic components, emulsifier components and polymeric components can be selected from those described or inferred in co-pending application Ser. No. 11/078,216 filed Mar. 11, 2005, the entirety of which is incorporated herein by reference.

In part, this invention can comprise an alternate method for emulsion and particulate formation. With reference to the preceding, a polymeric component can be incorporated with or contact a composition comprising an oil/fat component and an emulsifier component under conditions or at a pH not conducive for sufficient electrostatic interaction therewith. The pH can then be varied to change the net electrical charge of the emulsion, of the emulsified oil/fat component and/or of the polymeric component, sufficient to promote electrostatic interaction with and incorporation of the polymeric component. (See, e.g., FIG. 2B.) Without limitation, an emulsifier component can comprise a protein at a pH below its isoelectric point, to provide a net positive charge for subsequent interaction with another component.

Regardless of the method of preparation, the emulsion can be contacted with a wall component selected from polar lipids, proteins and/or carbohydrates. Various wall components will be known to those skilled in the art and made aware of this invention. Such emulsions, together with one or more wall components can be used as a feed material from a spray dryer. Accordingly, a corresponding emulsion can be processed into a dispersion of droplets comprising a wall component about emulsified oil/fat components. The dispersion can be introduced to and contacted with a hot drying medium to promote at least partial evaporation of the aqueous phase from the dispersion droplets, providing solid or solid-like particles comprising oil/fat, emulsifier and polymeric compositions within a wall component matrix.

Without limitation, with reference to the following examples, emulsions can be prepared using food-grade components and standard preparation procedures (e.g., homogenization and mixing). Initially, a primary aqueous emulsion comprising an electrically charged emulsifier component can be prepared by homogenizing an oil/fat component, an aqueous phase and an ionic emulsifier. Optionally, mechanical agitation or sonication can be applied to such a primary emulsion to disrupt any floc formation, and emulsion washing can be used to remove any non-incorporated emulsifier component. A secondary emulsion can be prepared by contacting a net-charged polymeric component (or other suitable charged material; e.g., associated colloid, nanoparticle or colloidal particle) with a primary emulsion. The polymeric component can have a net electrical charge opposite to at least a portion of the primary emulsion. Optionally, mechanical agitation or sonication can also be applied to disrupt any floc formation, and emulsion washing can be used to remove non-incorporated polymeric component. As discussed above, emulsion characteristics can be altered by pH adjustment to promote or enhance electrostatic interaction of the primary emulsion and a polymeric component. For purpose of illustration only, a primary emulsion can be prepared by homogenization of an oil/fat, water and lecithin to provide an oil/fat and emulsifier component composition comprising a net negative charge. A secondary emulsion can be prepared by contacting the primary emulsion with chitosan, comprising a net positive charge, under conditions sufficient to promote electrostatic interaction with the primary emulsion and provide the corresponding composition. Regardless of the method of preparation, a wall component can be introduced in conjunction or sequentially with either primary or secondary emulsion formation, prior to spray-drying.

Accordingly, this invention can also related, at least in part, to a composition comprising a substantially hydrophobic oil/fat component, an emulsifier component, a polymeric component and a wall material component. Consistent with the broader aspects of this invention, such a composition can comprise a plurality of component layers of any food-grade material, each layer comprising a net charge opposite that of at least a portion of an adjacent such material, within a wall component matrix upon drying. The resulting powdered or particulate material can be used to prepare a reconstituted emulsion upon introduction to an aqueous medium. Alternatively, such a material can be incorporated into a food or beverage product, such a product including but not limited to any emulsion-based foodstuff described herein or as would be otherwise known to those skilled in the art. Such foodstuffs include but are not limited to mayonnaise, salad dressings, sauces, dips, creams, gravies, spreads, puddings, yogurts, soups, coffee whiteners, desserts, dairy or soy beverages and the like. In addition, the dried material can be directly incorporated into low-moisture products during production, e.g., cookies, crackers, biscuits, cakes, cereals, dry mixes, granola, bars, confectionary products, candies, fillings and toppings.

### DETAILED DESCRIPTION OF CERTAIN EMBODIMENTS

Various aspects of this invention can be illustrated through the preparation, characterization and use of compositions comprising tuna oil emulsified and/or coated as described herein, dried and/or reconstituted for subsequent use. Such methods and compositions are non-limiting and representative of broader aspects relating to this invention.

Moisture and water activity. The final effect of drying a product is a lower moisture content along with a lower water activity. The moisture content (1-3%) and water activity (0.1-0.25) of spray-dried emulsion powders decreased with increasing air inlet temperature from 165 to 180° C. but not above that (Table 1). These results are consistent with the literature: the moisture content of spray-dried products was highest when operated at lowest temperature. The maximum moisture specification for most dried powders in the food industry is between 3% and 4%. In conjunction with the present invention, this level of moisture content could be achieved even by operating the spray-drier at the lowest air inlet temperature of 165° C. (feed rate=2.2 L/h).

TABLE 1
Effect of inlet temperature on properties of spray-dried tuna oil emulsion

| | Inlet Temperature (° C.) | | |
|---|---|---|---|
| Measured Properties | 165 | 180 | 195 |
| Moisture content | 2.84 ± 0.05^{a*} | 1.63 ± 0.24^{b} | 1.68 ± 0.39^{b} |
| (g water/100 g | | | |
| powder) | | | |
| Water activity (Aw) | 0.24 ± 0.01^{a} | 0.19 ± 0.01^{b} | 0.19 ± 0.02^{b} |
| Hydroperoxide | 2.27 ± 0.64^{a} | 3.22 ± 0.44^{a} | 2.89 ± 0.32^{a} |
| (mmol/kg oil) | | | |
| Total oil | 21.36 ± 0.79^{a} | 21.21 ± 0.34^{a} | 21.69 ± 0.63^{a} |
| (g/100 g powder) | | | |
| Hexane-extractable oil | 3.21 ± 0.74^{a} | 2.94 ± 0.18^{a} | 3.31 ± 0.28^{a} |
| (g/100 g powder) | | | |
| Encapsulated oil | 18.77 ± 0.68^{a} | 17.92 ± 0.77^{a} | 18.41 ± 0.82^{a} |
| (g/100 g powder) | | | |
| Encapsulation | 86.94 ± 3.89^{a} | 84.49 ± 3.64^{a} | 86.94 ± 3.80^{a} |
| efficiency | | | |
| (%) | | | |
| Droplet mean diameter | 0.36 ± 0.02^{a} | 0.38 ± 0.02^{a} | 0.37 ± 0.01^{a} |
| (d_{3,2},μm)** | | | |

*Within rows, means followed by different superscript letters differ significantly (P < 0.05).
**Reconstituted emulsion, for original emulsion Hydroperoxide = 0.86 ± 0.13 mmol/kg oil, d_{3,2} = 0.26 ± 0.01 μm.

Lipid Oxidation. Oxidation of oils is a major cause of their deterioration, and hydroperoxides formed by the reaction between oxygen and the unsaturated fatty acids are the primary products of this reaction. The hydroperoxide concentrations of the spray-dried emulsified tuna oil at different drying temperatures are shown in Table 1. There was no effect of drying temperature on the hydroperoxides of the tuna oil powders (P<0.05). The concentration of hydroperoxides of tuna oil emulsion increased from 0.86±0.13 mmol/kg oil in the original liquid emulsion to 2.79±0.48 mmol/kg oil in the spray-dried powder. During processing, tuna oil is exposed to air, high pressure and high temperature, which leads to an increase in lipid oxidation. For soybean oil, a hydroperoxide concentration less than 5 mmol/kg oil has previously been shown to indicate a low degree of lipid oxidation. The relatively low hydroperoxide level in our fresh powder would therefore seem to indicate that the tuna oil was relatively stable to oxidation during the spray-drying process.

Free oil and encapsulated efficiency. The amount of “free oil” in powdered emulsions is usually defined as that part of the oil that can be extracted with organic solvents. Nevertheless, it should be noted that the amount of free oil measured in an analytical test is highly dependent on the precise extraction conditions used. In a recent study, the “free oil” of powdered emulsions was considered to be equivalent to the hexane extractable oil. Danviriyakul, S., McClements, D. J., Decker, E. A., Nawar, W. W., & Chinachoti, P. (2002). Physical stability of spray-dried milk fat emulsion as affected by emulsifiers and processing conditions. Journal of Food Science, 67(6), 2183-2189. The amount of free oil in the powders (3.0-3.5 g/100 g powder) was found to be independent of air inlet temperature (P<0.05, Table 1). This result would suggest that the matrix system, but not the drying temperature, affected the amount of free oil. The encapsulation efficiency (EE) reflects the presence of free oil on the surface of the particles within the powder and the degree to which the wall matrix can prevent extraction of internal oil through a leaching process. Here, the EE values (85% to 87%) were unaffected by air inlet temperature (Table 1). Previous workers have reported EE values from 0% to 95% depending on the type and composition of wall material, the ratio of core material to wall material, the drying process used, and the stability and physicochemical properties of the emulsions. By comparison, the EE value for a multilayer emulsion system of this invention was towards the high end of previously reported EE values.

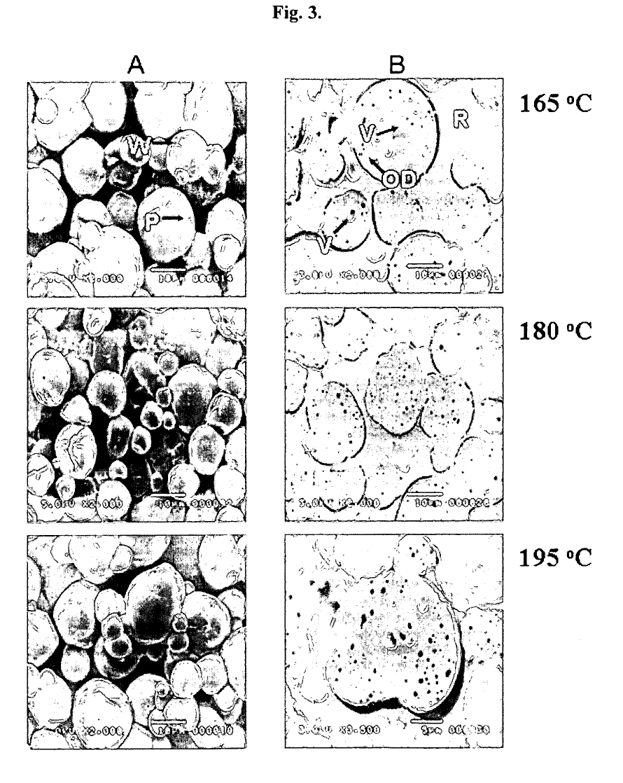

Powder morphology. Many properties of microencapsulated systems, such as the retention of core materials, flow properties and the protection of core materials from the environment, depend on their internal microstructure, suggesting characterization of internal powder structure. Drying temperature had no effect on the structure of the powder based on scanning electron microscopy (FIG. 3). All powder samples contained approximately spherical particles with a diameter in the range 5-30 μm (FIG. 3A). Some wrinkles or dimples on the surface were observed, consistent with the literature; that is, wrinkles or scars on the surface of the particles in spray-dried anhydrous milk fat powders consisting of sodium caseinate and maltodextrin. Wrinkles on powdered particle surfaces have also been reported for other carbohydrate-based microcapsules and have been attributed: to the results of mechanical stresses induced by uneven drying at different parts of the liquid droplets produced during the early stages of drying, to the movement of the moisture during the nonsaturated surface drying period, and to the effect of a surface tension-driven viscous flow. The powdered particles appeared to be largely free of cracks but the presence of some pores was observed. These pores may arise in the last phase of the drying process due to uneven shrinkage of the material. Porosity has been suggested to affect the extractability of fat from spray-dried milk powders through its effect on solvent penetration into the dry particles. The “free oil” measured using the solvent extraction procedure mentioned above may therefore have been due to the presence of these pores in the powdered particles. A considerable part of the free oil is believed to be surface fat or of fat globules from the interior of the microcapsules. It may be possible to reduce the level of pore formation and free oil by using amorphous lactose in the wall material to act as a barrier that limits the diffusion of the apolar solvent into the particles.

To study the inner structure of spray-dried microcapsules and how the core material is organized within the dry matrix, the capsules were “opened.” This procedure was carried out by dispersing powders in LR-White resin and then incubating under UV-light to polymerize the resin. The blocks containing embedded powder were then sectioned using a microtome (Poter Blum Ultra-Microtome MT-2, Ivan Sorvall, Inc., Norwalk, Conn.) The inner structure of the capsules (FIG. 3B) indicated that in all cases the core material was in the form of small droplets embedded in the wall matrix. The mean diameter of the droplets was between 0.2 and 1.0 μm, which was very similar to the dispersed phase droplets in the liquid emulsions prior to drying. In addition to the oil droplets there appeared to be a number of voids formed within each capsule (large circular regions labeled “V”), which are similar to those reported in the literature for other spray-dried emulsions using carbohydrates-based wall materials. Without restriction to any one theory or mode of operation, the formation of voids may be related to several mechanisms connected with atomization and spray-drying, e.g. evaporation of dissolved gases, expansion of the material due to the temperature increase, and formation of steam bubbles.

Powder color. Thermal treatments during processing can affect the quality of food products containing sugars through non-enzymatic browning reactions. Changes in the color of powders can be quantified by calorimetric measurements of tristimulus coordinates, such as L-(lightness), a-(redness and greenness) and b-(yellowness and blueness) values, as referenced above. Corn syrup solid (CSS) powder (DE 36) was used as a color control sample. There was no significant effect of drying temperature on the color (L, a, b values) of the spray-dried emulsions (P<0.05, Table 2). Nevertheless, the L-value of the powdered emulsions was smaller (less light) and the b-value was higher (more yellow) than the CCS control, probably due to some non-enzymatic browning reaction products occurring in the spray-dried emulsions. For example, the chitosan is known to have a small protein fraction, which may have reacted with the sugar molecules in the CCS.

TABLE 2
Effect of inlet temperature on color of spray-dried tuna oil emulsion

Color IndexCSS

| Inlet Temperature (° C.) | L | a | b |
|---|---|---|---|
| 165 | 97.7 ± 0.3^{ab*} | 0.3 ± 0.1^{ab} | 3.1 ± 0.4^{ab} |
| 180 | 96.9 ± 0.6^{b} | −0.3 ± 0.5^{b} | 5.2 ± 3.1^{b} |
| 195 | 96.7 ± 0.8^{b} | 0.2 ± 0.2^{ab} | 5.3 ± 3.0^{b} |
| CSS** | 99.1 ± 0.1^{a} | 0.8 ± 0.1^{a} | 1.7 ± 0.1^{a} |

*Within columns, means followed by different superscript letters differ significantly (P < 0.05)
**CSS was used for control

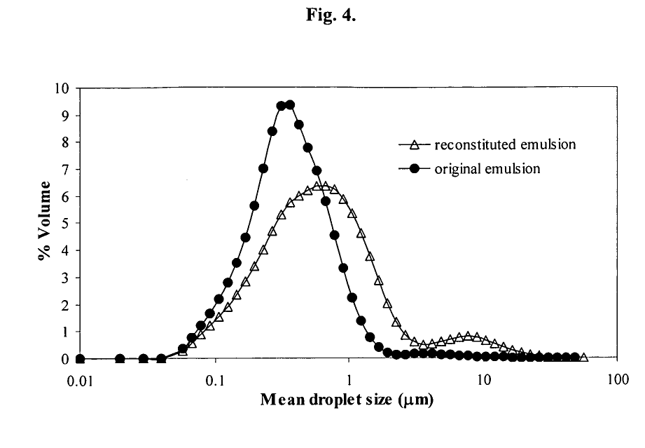

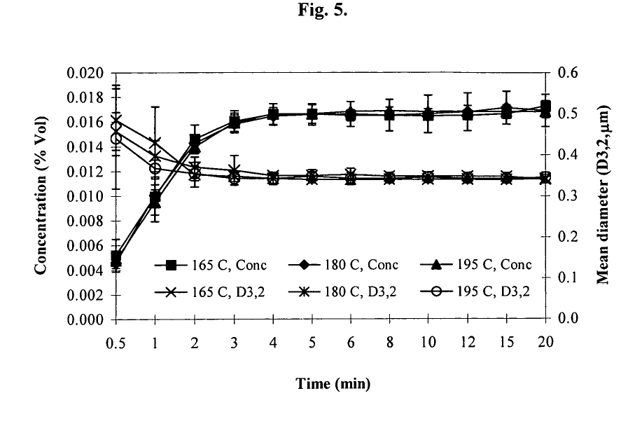

Reconstitution of emulsions powder. The rate and efficiency of powder dispersion is particularly important in the application of powdered food ingredients. For this reason, a laser diffraction technique was used to provide information about the rate and efficiency of the dispersion of the spray-dried emulsions. No significant increase in the final mean droplet diameter obtained after complete reconstitution of the powders in aqueous solutions was observed after drying and reconstitution at all drying temperatures (P≦0.05, Table 1). Nevertheless, a bimodal distribution was observed in the reconstituted emulsions (FIG. 4), which indicated the formation of some large particles (either flocculated or coalesced droplets). For studying the dispersibility, a small sample (˜0.3 g/mL of buffer) of the emulsion powder was added to a continuously stirred buffer solution contained within the stirring chamber of a laser diffraction instrument (Malvern Mastersizer Model 3.01, Malvern Instruments, Worcs., UK). The dispersibility of the powdered emulsion was then assessed by measuring the change in mean particle diameter and droplet concentration of the system as a function of time (FIG. 5). The droplet concentration increased with agitation time up to 3 min (0.016% vol) after which it reached a constant value. On the other hand, the mean particle diameter decreased from 0.5±0.1 μm at the beginning to 0.3 ±0.01 μm after 3 min stirring. The droplet concentration and mean particle size remained relatively constant at agitation times longer than 3 min. The larger particle sizes and lower droplet concentrations observed at the beginning of the measurement indicate considerable clumping of the emulsion powder. The rapid decrease in particle size and increase in droplet concentration indicated that the majority of the powder dissolved rather quickly giving a homogeneous suspension.

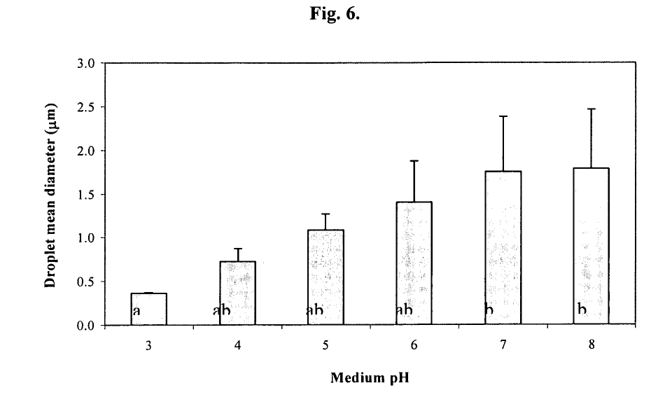

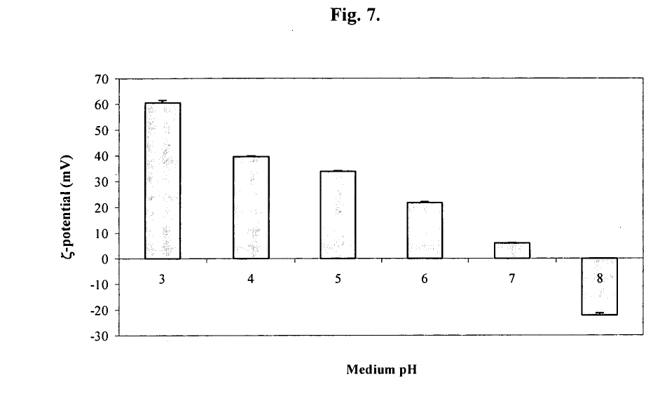

The influence pH on the stability of reconstituted emulsions was examined. A series of dilute emulsions (10 g solid/100 g emulsion) was prepared by dispersing powdered emulsions in a variety of aqueous solutions with different pH values (3 to 8). The emulsions were stored at room temperature for 24 h and then the mean particle diameter and electrical charge (ζ-potential ) were measured (FIGS. 6 and 7).

The ζ-potential of the reconstituted emulsions was positive at low pH values (<pH 8) but became negative at higher values (FIG. 7). The cationic groups on chitosan typically have pKₐ values around 6.3-7. See, Schulz, P. C., Rodriguez, M. S., Del Blanco, L. F., Pistonesi, M., & Agullo, E. (1998). Emulsification properties of chitosan. Colloid and Polymer Science, 276, 1159-1165. Hence, the chitosan begins to lose some of its charge around this pH. Consequently, there may have been a weakening in the electrostatic attraction between the chitosan and the lecithin-coated droplets, which may have led to the release of some of the adsorbed chitosan. Alternatively, some or all of the chitosan may have remained adsorbed to the droplet surfaces, but the droplets became negatively charged because the chitosan lost some of its positive charge. The reconstituted emulsions were stable to droplet aggregation at pH<5.0, but highly unstable at higher pH values (FIG. 4), as deduced from the large increase in mean particle diameter. The instability of the emulsions at higher pH values was probably because the magnitude of the ζ-potential was relatively low (FIG. 5), which reduced the electrostatic repulsion between the droplets, leading to extensive droplet flocculation. In addition, partial desorption of chitosan molecules from the droplet surfaces may have led to some bridging flocculation.

### EXAMPLES OF THE INVENTION

The following non-limiting examples and data illustrate various aspects and features relating to the compositions and the methods of the present invention, including the preparation oil/fat emulsions, encapsulated by emulsifier and polymeric components of the sort described herein, and use thereof in the preparation of powdered particulates for subsequent reconstitution or incorporation into foodstuffs. In comparison with the prior art, the present compositions and methods provide results and data which are surprising, unexpected and contrary thereto. It should, of course, be understood that these examples are included only for purpose of illustration, and that this invention is not limited to any particular combination of hydrophobic component, emulsifier, polymer or wall material set forth herein. Comparable utility and advantages can be realized using various other components consistent with the scope of this invention.

Materials. Powdered chitosan (molecular weight, medium; viscosity of 1 wt % solution in 1 wt % acetic acid, 200-800 Cps; deacetylation, 75% -85%; maximum moisture, 10 wt %; maximum ash, 0.5 wt %) was purchased from Aldrich Chemical Co. (St. Louis, Mo.). Powdered lecithin (Ultralec P; acetone insolubles, 97%; moisture. 1 wt %) was donated by ADM-Lecithin (Decatur, Ill.). Corn syrup solids (DRI SWEET®36, Code 335249; dextrose equivalent, 36; total solids, 97.2 wt %; moisture, 2.8 wt %; ash, 0.2 wt %) was obtained from Roquette America, Inc. (Keokuk, Iowa). Degummed, bleached and deodorized tuna oil was obtained from Maruha Co. (Utsunomiya, Japan). Analytical grade sodium acetate (CH₃COONa), hydrochloric acid (HCI) and sodium hydroxide (NaOH) were purchased from the Sigma Chemical Co. (St. Louis, Mo.). Distilled and deionized water was used for the preparation of all solutions.

Aw. The water activity of samples was measured by AquaLab Water Activity Meter (Series 3, Decagon Devices, Inc., Pullman Wash.) at 25° C.

Calculation of microencapsulation efficiency. The encapsulation efficiency (EE) was calculated from the quantitative determinations detailed above as follows:
EE=Encapsulated oil (g/100 g powder)×100/Total oil (g/100 g powder)

Scanning electron microscopy. Internal and surface morphology of the powders were evaluated by Scanning Electron Microscopy (SEM) using the method of Hardas and others. See, Hardas, N., Danviriyakul, S., Foley, J. L., Nawar, W. W., & Chinachoti, P. (2000). Accelerated stability studies of microencapsulated anhydrous milk fat. Lebensm.-Wiss. u.-Technology, 33, 506-513. The images were viewed by scanning electron microscope at 3.0-5.0 kV (JEOL 5400, JEOL, Japan).

Statistics. All experiments were carried out in at least duplicate using freshly prepared samples and results are reported as the mean and standard derivation of these measurements.

### Example 1

Solution preparation. A stock buffer solution was prepared by dispersing 100 mM sodium acetate and acetic acid in water and then adjusting the pH to 3.0. An emulsifier solution was prepared by dissolving 3.53 wt % lecithin into stock buffer solution. The emulsifier solution was sonicated for 1 min at a frequency of 20 kHz, amplitude of 70% and duty cycle of 0.5 s (Model 500, sonic disembrator, Fisher Scientific, Pittsburgh, Pa.) to disperse the emulsifier. The pH of the solution was adjusted to 3.0 using HCl or NaOH, and then the solution was stirred for about 1 h to ensure complete dissolution of the emulsifier. A chitosan solution was prepared by dissolving 1.5 wt % powdered chitosan in sodium acetate-acetic acid buffer solution. A corn syrup solids solution was prepared by dispersing 50 wt % corn syrup solids in sodium acetate-acetic acid buffer solution.

### Example 2

Liquid emulsion preparation. Tuna oil-in-water emulsions were prepared containing 5 wt % tuna oil, 1 wt % lecithin, 0.2 wt % chitosan and 20 wt % corn syrup solid (DE 36). A concentrated tuna oil-in-water emulsion (15 wt % oil, 3 wt % lecithin) was made by blending 15 wt % tuna oil with 85 wt % aqueous emulsifier solution (3.53 wt % lecithin) using a high-speed blender (M133/1281-0, Biospec Products, Inc., ESGC, Switzerland), followed by three passes at 5,000 psi through a single-stage high pressure valve homogenizer (APV-Gaulin, Model Mini-Lab 8.30H, Wilmington, Mass.). This primary emulsion was diluted with aqueous chitosan solution to form a secondary emulsion (5 wt % tuna oil, 1 wt % lecithin and 0.2 wt % chitosan). Any flocs formed in the secondary emulsion were disrupted by passing it once through a high-pressure valve homogenizer at a pressure of 4,000 psi. Secondary emulsions containing 20 wt % corn syrup solids were prepared by mixing the initial secondary emulsions with corn syrup solids solutions. The emulsions were stored at 4° C. overnight (12-15 h) in the dark prior to spray-drying.

### Example 3

Spray-dried emulsion preparation. Spray-drying was performed at a feed rate of 2.2 L/h at 165, 180 and 195° C. inlet temperature using Niro spray-dryer with a centrifugal atomizer (Nerco-Niro, Nicolas & Research Engineering Corporation, Copenhagen, Denmark). The powders were vacuumed and stored in a hermetically sealed laminated pouch at −40° C. until analysis.

### Example 4

Moisture content. Duplicate samples of approximately 2 g of powder were placed in an aluminum pan and dried for 24 h at 70° C. and 29 in. Hg in vacuum oven (Fisher Scientific, Fairlawn, N.J.). Moisture content was calculated from the weight difference.

### Example 5

Extraction of free oil. Fifteen-mL hexane was added to 2.5 g powder. The mixture was mixed with a vortex mixer (Fisher Vertex Genie 2, Scientific Industries, Inc, Bohemia) for 2 min and then centrifuged (Sorvall RC-5B Refrigerated Superspeed Centrifuge, Du Pont Company, Wilminngton, Del.) at 8,000 rpm for 20 min. The supernatant was filtered, the filter paper (Whatman, Maidstone, Kent, U.K.) washed twice with hexane, and hexane was evaporated in a rotary evaporator (RE 111 Rotavapor, Type KRvr TD 65/45, BUCHI, Switzerland) at 70° C., and the solvent-free extract was dried at 105° C. The amount of encapsulated oil was determined gravimetrically.

### Example 6

Extraction of encapsulated oil. Two-mL of acetate buffer (pH 3.0) was added to 0.5 g powder free of surface oil and vertexed for 1 min. The resulting solution was then extracted with 25 mL hexane/isopropanol (3:1 v/v). The tubes were then shaken for 15 min at 160 rpm using an automatic shaker (Innova 4080 Incubator Shaker, New Brunswick Scientific Co. Inc., N.J.), and centrifuged for another 15 min. The clear organic phase was collected and the aqueous phase reextracted with the solvent mixture. After filtration through anhydrous Na₂SO₄ the solvent was evaporated in a rotary evaporator (RE 111 Rotavapor, Type KRvr TD 65/45, BUCHI, Switzerland) at 70° C., and the solvent-free extract was dried at 105° C. The amount of encapsulated oil was determined gravimetrically.

### Example 7

Extraction of total oil. Starting from intact dried powders, two-mL of acetate buffer (pH 3.0) was added to 0.5 g powder and vortexed for 1 min. Total oil was extracted using the same method as described above for extraction of encapsulated oil.

### Example 8

Color measurement. The reflectance spectra of spray-dried emulsions were measured using a UV-visible spectrophotometer (UV-2101 PC, Shimadzu Scientific Instruments, Columbia, Md.). During the measurements, the dried emulsions were contained in a 0.5 cm path length measurement cell with a black back plate. Spectra were obtained over the wavelength range 380-780 nm using a scanning speed of 700 nm min⁻¹. Spectral reflectance measurements were made using an integrating sphere arrangement (ISR-260, Shimadzu Scientific Instruments, Columbia, Md.). The spectral reflectance of the emulsions was measured relative to a barium sulfate (BaSO₄) standard. The color of samples was reported in terms of the L, a, b color system used in the literature. See, Chantrapornchai, W., Clydesdale, F., & McClements, D. J. (1999). Theoretical and experimental study of spectral reflectance and color of concentrated oil-in-water emulsions. Journal of Colloid and Interface Science, 218, 324-330.

### Example 9

Lipid Oxidation Measurement. Lipid hydroperoxide was measured by a modifiled literature method after an extraction step in which 0.3 mL of reconstituted emulsion (0.1 g of emulsion powder in 0.3 mL of acetate buffer) was added to 1.5 mL of isooctane-2-propanal (3:1 v:v) followed by vortexing three times for 10 s each and centrifuging for 2 min at 3400 g (Centrific™ Centrifuge, Fisher Scientific, Fairlawn, N.J.). See, Mancuso, J. R., McClements, D. J., & Decker, E. A. (1999). The effects of surfactant type, pH, and chelators on the oxidation of salmon oil-in-water emulsions. Journal of agricultural and Food Chemistry, 47, 4112-4116. Next, the organic phase (0.2 mL total volume containing 0.015 to 0.2 mL of lipid extract) was added to 2.8 mL of methanol-butanol (2:1 v:v), followed by 15 μL of thiocyanate solution (3.94 M) and 15 μL of ferrous iron solution (prepared by mixing 0.132 M BaCl₂ and 0.144 M FeSO₄ in acidic solution). The solution was vortexed, and the absorbance at 510 nm was measured after 20 min. Lipid hydroperoxide concentrations were determined using a cumene hydroperoxide standard curve.

### Example 10

Reconstituted emulsion droplet diameter; The powder was reconstituted to 10 g solids/100 g reconstituted emulsion by dissolving 0.5 g powder in 4.5 mL of acetate buffer (pH 3.0). One hour after reconstitution, the emulsion was analyzed for oil droplet diameter distribution using a static light scattering instrument (Malvern Mastersizer Model 3.01, Malvern Instruments, Worcs., UK). To prevent multiple scattering effects the emulsions were diluted with pH-adjusted double-distilled water prior to analysis so the droplet concentration was less than 0.02 wt %.

### Example 11

Dispersibility of dried emulsion. A small sample (˜0.3 mg/mL of buffer) of the emulsion powder was added to a continuously stirred buffer solution contained within the stirring chamber of a laser diffraction instrument (Malvern Mastersizer Model 3.01, Malvern Instruments, Worcs., UK). The dispersibility of the powdered emulsion was then assessed by measuring the change in mean particle diameter and concentration as a function of time as the powder was progressively dispersed.

### Example 12

Influence of medium pH. The powder (0.5 g) was dissolved in 4.5 mL acetate buffer at the desired pH (3 to 8). The emulsions were transferred into glass test tubes (internal diameter=15 mm, height=125 mm), which were then stored at room temperature prior to analysis. The particle size distribution of the emulsions was measured using the same conditions as described above, but diluting the emulsion with pH-adjusted water of the same pH as the original emulsion. The electrical charge (ξ potential) of oil droplets in the emulsions was determined using a particle electrophoresis instrument (ZEM5003, Zetamaster, Malvern Instruments, Worcs., UK). The emulsions were diluted to a droplet concentration of approximately 0.008 wt % with pH-adjusted double-distilled water prior to analysis to avoid multiple scattering effects.

As shown above, high quality microencapsulated tuna oil can be produced by spray-drying oil-in-water emulsions containing corn syrup solids and oil droplets surrounded by multilayer interfacial membranes (lecithin:chitosan). Spray-drying produced powdered emulsions consisting of smooth spheroid powdered particles (diameter=5-30 μm) containing small tuna oil droplets (diameter<1 μm) embedded within a carbohydrate wall matrix. The structure of the microcapsules was unaffected by drying temperature (165 to 195° C.). The powders had relatively low moisture contents (<3%), high oil retention levels (>85%) and rapid water dispersibility (<1 minute). The novel interfacial engineering technology of this invention is effective for producing a range of spray-dried encapsulated hydrophobic oil/fat components, a representative non-limiting example of which is tuna oil. Other such powdered compositions can be produced by this invention, with good physicochemical properties and dispersibility indicating widespread use in food additive applications.

We claim:

1. A method of preparing an emulsion composition, said method comprising:
providing an aqueous medium comprising a hydrophobic component;
contacting said hydrophobic component and an emulsifier component, wherein at least a portion of said emulsifier component has a net charge;
contacting said emulsion and a polymeric component, wherein at least a portion of said polymeric component has a net charge opposite said emulsifier net charge; and
contacting said emulsion/polymeric component with a wall component.

2. The method of claim 1, wherein said aqueous medium comprises at least one of said polymeric component and said wall component.

3. The method of claim 1, wherein said hydrophobic component is a fat or an oil component selected from corn oil, soybean oil, sunflower oil, canola oil, rapeseed oil, olive oil, peanut oil, algal oil, nut oils, plant oils, vegetable oils, fish oils, flavor oils, animal fats, vegetable fats and combinations thereof.

4. The method of claim 1, wherein said emulsifier component is selected from licithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

5. The method of claim 1, wherein said polymeric component is selected from proteins, polysaccharides and combinations thereof.

6. The method of claim 1, wherein said wall component is selected from lipids, proteins and carbohydrates.

7. The method of claim 1 where at least one component net charge is provided by adjusting medium pH.

8. The method of claim 7, wherein said emulsifier component comprises a protein and said medium pH is lowered below the isoelectric point of said protein.

9. The method of claim 1, wherein said polymeric component is contacted with another emulsifier component, wherein at a least a portion of said other emulsifier component has a net charge opposite said polymeric component net charge.

10. The method of claim 1, wherein said aqueous medium is at least partially evaporated to provide a particulate.

11. The method of claim 10, wherein said particulate is reconstituted in an aqueous medium.

12. A method of preparing an emulsion, said method comprising providing an aqueous medium comprising a hydrophobic component, emulsifier component having a net charge, a polymeric component, wherein at least a portion of said polymeric component has a net charge opposite said emulsifier component net charge, and a wall component.

13. The method of claim 12, wherein said emulsion is reconstituted in said medium.

14. The method of claim 12, wherein said hydrophobic component is a fat or an oil component selected from corn oil, soybean oil, sunflower oil, canola oil, rapeseed oil, olive oil, peanut oil, algal oil, nut oils, plant oils, vegetable oils, fish oils, flavor oils, animal fats, vegetable fats and combinations thereof.

15. The method of claim 12, wherein said emulsifier component is selected from licithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

16. The method of claim 12, wherein said polymeric component is selected from proteins, polysaccharides and combinations thereof.

17. The method of claim 12, wherein said wall component is selected from lipids, proteins and carbohydrates.

18. An emulsion composition, comprising:
an emulsion of a hydrophobic component in an aqueous medium, said emulsion comprising an emulsifier component having a net charge;
a polymeric component, wherein at least a portion of said polymeric component has a net charge opposite that of the emulsifier component net charge; and
a wall component about said emulsifier and polymeric components.

19. The emulsion composition of claim 18, wherein the hydrophobic component is a fat or an oil component selected from corn oil, soybean oil, sunflower oil, canola oil, rapeseed oil, olive oil, peanut oil, algal oil, nut oils, plant oils, vegetable oils, fish oils, flavor oils, animal fats, vegetable fats and combinations thereof.

20. The emulsion composition of claim 18, wherein said emulsifier component is selected from licithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

21. The emulsion composition of claim 18, wherein said polymeric component is selected from proteins, polysaccharides and combinations thereof.

22. The emulsion composition of claim 18, wherein said wall component is selected from lipids, proteins and carbohydrates.

23. The emulsion composition of claim 18 incorporated into one of a food product and a beverage.

24. The emulsion composition of claim 18, wherein said aqueous medium is at least partially evaporated to provide a particulate.

25. The emulsion composition of claim 24 reconstituted in an aqueous medium.

26. The emulsion composition of claim 24 incorporated into one of a food product and a beverage.
